(19) United States
(12) Patent Application Publication
(10) Pub. No.: US 2022/0332660 A1
(43) Pub. Date: Oct. 20, 2022

(54) Stable Aqueous Compositions of Fertilizer and Agriculturally Active Compound

(71) Applicant: BASF SE, Ludwigshafen (DE)

(72) Inventor: Shawn DICKESS, Cincinnati, OH (US)

(21) Appl. No.: 17/754,214

(22) PCT Filed: Sep. 28, 2020
(86) PCT No.: PCT/EP2020/077097

§ 371 Date: Mar. 28, 2022

Related U.S. Application Data
(60) Provisional application No. 62/908,232, filed on Sep. 30, 2019.

(51) Int. Cl. C05G 5/27; C05G 3/60; C05C 1/00; C05C 3/00

(52) U.S. Cl. CPC C05G 5/27; C05G 3/60; C05C 1/00; C05C 3/005

(57) ABSTRACT

Disclosed herein is an aqueous composition including at least one agriculturally active compound, at least one fertilizer and a compatibilizer blend. Further disclosed herein is a method of making an aqueous composition. The aqueous composition disclosed herein is stable.

### TECHNICAL FIELD

The present invention relates to an aqueous composition comprising at least one agriculturally active compound, at least one fertilizer, and a compatibilizer blend. The present invention also relates to a method of making an aqueous composition. The aqueous composition of the present invention is stable.

### BACKGROUND

Pesticides such as herbicides can be used prior to planting (pre-emergent use) to rid an area of weeds and/or to prevent growth of weeds in the area. Additionally, there is a need to treat an area after planting (post-emergent use) so as to prevent weed growth in the early stages of plant growth. Furthermore, there is often a need to apply a fertilizer to an area prior to planting in order to enrich the soil with nutrients that are essential for the plant growth. This need typically also extends for a period after planting, so that the nutrient profile in the soil remains optimal during plant establishment. The application of pre-emergent and post-emergent herbicide and fertilizer treatments can be time consuming, particularly on a commercial scale. It is preferred to spray a solution containing both a fertilizer and herbicide or a pesticide.

However, the compatibility of fertilizers with pesticides is a persistent problem. There are two general types of incompatibilities: chemical and physical incompatibilities. Among these two incompatibility types, the physical incompatibility is the most serious, since the chemical incompatibility can be generally avoided beforehand by evaluating the chemical nature of the fertilizer and the pesticide. Physical incompatibility occurs most frequently when the combination of the fertilizers, such as a liquid fertilizer, and the pesticide results in precipitation or phase separation, which leads to difficulties such as clogging of the spray filters and nozzles. It also leads to an economic loss as the effective amount of the mixture of fertilizer and pesticide is reduced due to precipitation.

The prior art discloses pesticide suspensions of fertilizer compatible compositions employing surfactants. However, they are found to suffer from one major problem, which is foaming. The foaming problem can lead to an inaccurate spray volume of the fertilizer mix.

The pesticide is available as a suspension concentrate. Accordingly, it is an object of the presently claimed invention to provide a composition comprising a combination of a fertilizer with a suspension concentrate of a pesticide which is devoid of precipitation and phase separation. It is also an object of the presently claimed invention to provide a combination of a fertilizer with a suspension concentrate of a pesticide which is stable at different temperature conditions.

### SUMMARY

Surprisingly, it was found that by adding certain compatibilizers to the combination of a fertilizer and a suspension concentrate of a pesticide, the resulting aqueous composition is not only stable, but both a precipitation and a phase separation are prevented.

Thus, in one aspect, the presently claimed invention is directed to an aqueous composition comprising,
(a) at least one agriculturally active compound,
(b) at least one fertilizer, and
(c) a compatibilizer blend comprising
   (i) at least one cationic polymer containing at least one quaternary nitrogen atom;
   (ii) at least one compound of general formula (I)

R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, diesel, paraffins, kerosene, esters of saturated or unsaturated C₆-C₃₀ fatty acids, and mixtures thereof.

In another aspect, the presently claimed invention is directed to a method of making an aqueous composition comprising contacting at least one agriculturally active compound with at least one fertilizer and a compatibilizer blend, as described above.

### DETAILED DESCRIPTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to an aqueous composition comprising,
(d) at least one agriculturally active compound,
(e) at least one fertilizer, and
(f) a compatibilizer blend comprising
   (i) at least one cationic polymer containing at least one quaternary nitrogen atom;
   (ii) at least one compound of general formula (I)

R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30,
the sum of x+y is in the range from 2 to 50; and
(iii) at least one additive selected from mineral oil, diesel, paraffins, kerosene, esters of saturated or unsaturated C₆-C₃₀ fatty acids and mixtures thereof.

The aqueous composition of the present invention has a pH in the range from 1.0 to 8.0.

Agriculturally Active Compound

In an embodiment, the aqueous composition of the present invention comprises at least one agriculturally active compound. The at least one agriculturally active compound is a pesticide. The pesticide is selected from fungicides, insecticides and herbicides.

In an embodiment, the at least one agriculturally active compound is a suspension concentrate.

Mixtures of pesticides of two or more of the abovementioned classes may also be used.

In an embodiment, the amount of the at least one agriculturally active compound is in the range of 1.0 wt. % to 20.0 wt. %, preferably in the range of 2.0 wt. % to 10.0 wt. %, based on the total weight of the aqueous composition.

The skilled person is familiar with such pesticides, which can be found, for example, in the Pesticide Manual, 15th Ed. (2009), The British Crop Protection Council, London. The following list give examples of pesticides which may be used as pesticide.

In an embodiment of the present invention, the fungicides are selected from respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors and plant defense inducers.

A) Respiration Inhibitors

Inhibitors of complex III at Qo site (e.g. strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyri carb/chlorodincarb, famoxadone, fenamidone; Inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[(3-(acetoxymethoxy)-4-methoxy-pyridine-2-carbonyl]amino]-6-methyl-4,9-dioxo-1,5-dioxonan-7-yl] 2-methylpropanoate,[(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-((3-(1,3-benzodioxol-5-ylmethoxy)-4-methoxy-pyridine-2-carbonyl]amino]-6-methyl-4,9-dioxo-1,5-dioxonan-7-yl] 2-methylpropanoate;

Inhibitors of complex II (e. g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide; Other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentinsalts, such as fentin-acetate, fentin chloride or fentin hydroxide; ametoctradin; and silthiofam;

B) Sterol Biosynthesis Inhibitors (SBI Fungicides)

C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, triforine;

Delta14-reductase inhibitors: aldimorph, dodemorph, dodemorph-acetate, fenpropimorph, tridemorph, fenpropidin, piperalin, spiroxamine; Inhibitors of 3-keto reductase: fenhexamid;

C) Nucleic Acid Synthesis Inhibitors

Phenylamides or acyl amino acid fungicides: benalaxyl, benalaxyl-M, kiralaxyl, metalaxyl, metalaxyl-M (mefenoxam), ofurace, oxadixyl;

Others: hymexazole, octhilinone, oxolinic acid, bupirimate, 5-fluorocytosine, 5-fluoro-2-(ptolylmethoxy) pyrimidin-4-amine, 5-fluoro-2-(4-fluorophenylmethoxy)pyrimidin-4-amine;

D) Inhibitors of Cell Division and Cytoskeleton

Tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine Other cell division inhibitors: diethofencarb, ethaboxam, pencycuron, fluopicolide, zoxamide, metrafenone, pyriofenone;

E) Inhibitors of Amino Acid and Protein Synthesis

Methionine synthesis inhibitors (anilino-pyrimidines): cyprodinil, mepanipyrim, pyrimethanil; Protein synthesis inhibitors: blasticidin-S, kasugamycin, kasugamycin hydrochloride-hydrate, mildiomycin, streptomycin, oxytetracyclin, polyoxine, validamycin A;

F) Signal Transduction Inhibitors

MAP/histidine kinase inhibitors: fluoroimid, iprodione, procymidone, vinclozolin, fenpiclonil, fludioxonil;

G protein inhibitors: quinoxyfen;

G) Lipid and Membrane Synthesis Inhibitors

Phospholipid biosynthesis inhibitors: edifenphos, iprobenfos, pyrazophos, isoprothiolane; Lipid peroxidation: dicloran, quintozene, tecnazene, tolclofos-methyl, biphenyl, chloroneb, etridiazole;

Phospholipid biosynthesis and cell wall deposition: dimethomorph, flumorph, mandipropamid, pyrimorph, benthiavalicarb, iprovalicarb, valifenalate and N-(1-(1-(4-cyano-phenyl)-ethanesulfonyl)-but-2-yl) carbamic acid-(4-fluorophenyl) ester; Compounds affecting cell membrane permeability and fatty acids: propamocarb, propamocarb-hydrochlorid

H) Inhibitors with Multi Site Action

Inorganic active substances: Bordeaux mixture, copper acetate, copper hydroxide, copperoxychloride, basic copper sulfate, sulfur;

Thio- and dithiocarbamates: ferbam, mancozeb, maneb, metam, metiram, propineb, thiram, zineb, ziram;

Organochlorine compounds (e.g. phthalimides, sulfamides, chloronitriles): anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-Nethyl-4-methyl-benzenesulfonamide;

Guanidines and others: guanidine, dodine, dodine free base, guazatine, guazatine-acetate, iminoctadine, iminoctadine-triacetate, iminoctadine-tris(albesilate), dithianon;

I) Cell Wall Synthesis Inhibitors

Inhibitors of glucan synthesis: validamycin, polyoxin B; melanin synthesis inhibitors: pyroquilon, tricyclazole, carpropamid, dicyclomet, fenoxanil;

J) Plant Defence Inducers

Acibenzolar-S-methyl, probenazole, isotianil, tiadinil, prohexadione-calcium; phosphonates: fosetyl, fosetyl-aluminum, phosphorous acid and its salts;

K) Unknown Mode of Action

Bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-Nmethyl formamidine, N′-(5-difluoromethyl-2-methyl-4-(3-trimethylsilanyl-propoxy)-phenyl)-Nethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, methoxy-acetic acid 6-tert-butyl-8-fluoro-2,3-dimethyl-quinolin-4-yl ester, N-Methyl-2-{1-[(5-methyl-3-trifluoro methyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl) cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;

L) Antifungal Biocontrol Agents, Plant Bioactivators:

Ampelomyces quisqualis (e.g. AQ 10® from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD® Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida oleophila 1-82 (e.g. ASPIRE from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446: PRESTOP® from Verdera, Finland), Coniothyrium minitans (e.g. CONTANS® from Prophyta, Germany), Cryphonectria parasitica (e.g. Endothia parasitica from CNICM, France), Cryptococcusalbidus (e.g. YIELD PLUS' from Anchor Bio-Technologies, South Africa), Fusariumoxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTIBOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone Biolnnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL from Agrimm Technologies Ltd, NZ), T. harzianum T-22 (e.g. PLANTSHIELD® der Firma BioWorks Inc., USA), T. harzianum TH 35(e.g. ROOT PRO from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICCO12 and T. viride ICCO80 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), Ulocladium oudemansii HRU3 (e.g. BOTRY-ZEN® from Botry-Zen Ltd, NZ).

In an embodiment of the present invention the herbicides are selected from acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, pyrimidinedione and acetolactate synthase inhibitors.

Acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;

Amino acid derivatives: bilanafos, glyphosate, glufosinate, sulfosate;

Aryloxyphenoxypropionates: clodinafop, cyhalofop-butyl, fenoxaprop, fluazifop, haloxyfop, metamifop, propaquizafop, quizalofop, quizalofop-P-tefuryl;

Bipyridyls: diquat, paraquat;

(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;

Cyclohexanediones: butroxydim, clethodim, cycloxydim, profoxydim, sethoxydim, tepraloxydim, tralkoxydim;

Dinitroanilines: benfluralin, ethalfluralin, oryzalin, pendimethalin, prodiamine, trifluralin;

Diphenyl ethers: acifluorfen, aclonifen, bifenox, diclofop, ethoxyfen, fomesafen, lactofen, oxyfluorfen;

Hydroxybenzonitriles: bomoxynil, dichlobenil, ioxynil;

Imidazolinones: imazamethabenz, imazamox, imazapic, imazapyr, imazaquin, imazethapyr;

Phenoxy acetic acids: clomeprop, 2,4-dichlorophenoxyacetic acid (2,4-D), 2,4-DB, dichlorprop, MCPA, MCPA-thioethyl, MCPB, Mecoprop;

Pyrazines: chloridazon, flufenpyr-ethyl, fluthiacet, norflurazon, pyridate;

Pyridines: aminopyralid, clopyralid, diflufenican, dithiopyr, fluridone, fluroxypyr, picloram, picolinafen, thiazopyr, triclopyr (2-[(3,5,6-trichloro-2-pyridinyl)oxy] acetic acid, butoxyethyl ester);

Sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;

Triazines: ametryn, atrazine, cyanazine, dimethametryn, ethiozin, hexazinone, metamitron, metribuzin, prometryn, simazine, terbuthylazine, terbutryn, triaziflam;

Ureas: chlorotoluron, daimuron, diuron, fluometuron, isoproturon, linuron, methabenzthiazuron, tebuthiuron;

Pyrimidinedione: saflufenacil, bromacil, butafenacil, lenacil, terbacil;

Acetolactate synthase inhibitors: bispyribac-sodium, cloransulam-methyl, diclosulam, florasulam, flucarbazone, flumetsulam, metosulam, ortho-sulfamuron, penoxsulam, propoxy carbazone, pyribambenz-propyl, pyribenzoxim, pyriftalid, pyriminobac-methyl, pyrimisulfan, pyrithiobac, pyroxasulfone, pyroxsulam;

Others: amicarbazone, aminotriazole, anilofos, beflubutamid, benazolin, bencarbazone, benfluresate, benzofenap, bentazone, benzobicyclon, bicyclopyrone, bromobutide, butamifos, cafenstrole, carfentrazone, cinidon-ethyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, propanil, propyzamide, quinclorac, quinmerac, mesotrione, methyl arsenic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, sulcotrione, sulfentrazone, tefuryltrione, tembotrione, thiencarbazone, topramezone, (3-[2-chloro-4-fluoro-5-(3-methyl-2,6-dioxo-4-trifluoromethyl-5 3,6-dihydro-2Hpyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

In an embodiment of the present invention, the insecticides are selected from organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds and mixed function oxidase inhibitors.

Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphosmethyl, profenofos, prothiofos, sulprophos, tetrachlorvinphos, terbufos, triazophos, trichlorfon;

Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

Pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, py rethrin I and II, resmethrin, silafluofen, tau-fluvalinate, tefluthrin, tetramethrin, tralomethrin, transfluthrin, profluthrin, dimefluthrin;

Insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors:

spirodiclofen, spiromesifen, spirotetramat;

Nicotinic receptor agonists/antagonists compounds: clothianidin, dinotefuran, flupyradifurone, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane; GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioicacid amide;

Macrocyclic lactone insecticides: abamectin, emamectin, milbemectin, lepimectin, spinosad, spinetoram;

Mitochondrial electron transport inhibitor (METI) I acaricides: fenazaquin, pyridaben, tebufenpyrad, tolfenpyrad, flufenerim;

METI II and Ill compounds: acequinocyl, fluacyprim, hydramethylnon;

Uncouplers: chlorfenapyr;

Oxidative phosphorylation inhibitors: cyhexatin, diafenthiuron, fenbutatin oxide, propargite;

Moulting disruptor compounds: cryomazine;

Mixed function oxidase inhibitors: piperonyl butoxide;

Sodium channel blockers: indoxacarb, metaflumizone;

Others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, dinotefuran and pyrifluquinazon.

Fertilizer

The term “fertilizer” is to be understood as a chemical compound applied to promote the plant growth. Fertilizers are typically applied either through the soil (for uptake by plant roots), through soil substituents (also for uptake by plant roots), or by foliar feeding (for uptake through leaves).

In an embodiment, the at least one fertilizer is selected from the group of nitrogen, phosphate, potash, sulfur, and combinations thereof.

In an embodiment, the at least one fertilizer is selected from inorganic ammonium salts.

In an embodiment, inorganic ammonium salts are selected from ammonium chloride, calcium ammonium nitrate, anhydrous ammonia, ammonium sulfate, urea ammonium nitrate, super phosphoric acid, diammonium phosphate, ammonium phosphate sulfate, ammonium phosphate sulfate nitrate, nitro phosphate, urea ammonium phosphate, mono ammonium phosphate, nitro phosphate, ammonium nitrate phosphate, ammonium polyphosphate, ammonium phosphate, mono potassium phosphate and urea phosphate.

In an embodiment, the at least one fertilizer is selected from ammonium sulfate, ammonium polyphosphate and urea ammonium nitrate.

In an embodiment, the at least one fertilizer is present in amount in the range of 15.0 wt. % to 80.0 wt. %, based on the total weight of the aqueous composition.

Compatibilizer Blend

In an embodiment, the aqueous composition of the presently claimed invention comprises a compatibilizer blend.

The term ‘compatibilizer’ refers to a component which aids in the formation of a stable formulation of a fertilizer and a pesticide which are otherwise not compatible.

In an embodiment, the compatibilizer blend of the present invention comprises

(iv) at least one cationic polymer containing at least one quaternary nitrogen atom;

(v) at least one compound of general formula (I)

R₁—(O—CH₂—CH(CH₃))ₓ—(O—CH₂—CH₂)_{y}—OH

wherein

R₁ is a linear or branched, unsubstituted or substituted C₈-C₂₂-alkyl;

x is from 1 to 30;

y is from 1 to 30, and

the sum of x+y is in the range from 2 to 50; and

(vi) at least one additive selected from mineral oil, diesel, paraffins, kerosene, esters of saturated or unsaturated C₆-C₃₀ fatty acids and mixtures thereof.

In another embodiment, the compatibilizer blend may further include at least one solvent.

In another embodiment, the compatibilizer blend further comprises a copolymer of (meth)acrylate and stearyl (meth)acrylate.

In another embodiment, the compatibilizer blend may further comprise water.

In an embodiment, the compatibilizer blend is present in an amount in the range of 1.0 wt. % to 10.0 wt. %, based on the total weight of the aqueous composition.

In another embodiment, the compatibilizer blend is present in an amount in the range of 1.0 wt. % to 7.0 wt. %, based on the total weight of the aqueous composition.

Cationic Polymer Containing at Least One Quaternary Nitrogen Atom

In an embodiment, the compatibilizer blend of the present invention comprises at least one cationic polymer containing at least one quaternary nitrogen atom.

In another embodiment, the at least one cationic polymer containing at least one quaternary nitrogen atom is a reaction product of:

(A) at least one ethylenically unsaturated, quaternizable or quaternized monomer; and

(B) optionally at least one ethylenically unsaturated, non-quaternizable monomer.

In another embodiment of the present invention, the ethylenically unsaturated, quaternizable or quaternized monomer is selected from amino alkyl acrylates, methacrylates, N,N,N-trialkyl aminoalkyl acrylates and N,N,N-trialkyl aminoalkyl methacrylates.

In another embodiment, the ethylenically unsaturated, quaternizable or quaternized monomer is selected from N,N,N-trialkyl aminoalkyl acrylates and N,N,N-trialkyl aminoalkyl methacrylates.

In an embodiment of the present invention, the N,N,N-trialkyl aminoalkyl acrylates and N,N,N-trialkyl aminoalkyl methacrylate are of the general formula (II)

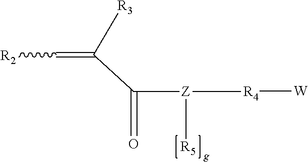

wherein
R₂ and R₃ are independently of one another, selected from hydrogen, C₁-C₈ linear or branched alkyl, methoxy, ethoxy, 2-hydroxyethoxy, 2-methoxyethoxy and 2-ethoxyethyl;
R₄ is alkylene or hydroxyalkylene having 1 to 24 carbon atoms, optionally substituted by alkyl, preferably C₂H₄, C₃H₆, C₄H₈, CH₂—CH(OH)—CH₂;
R₅ is hydrogen or methyl;
g is 0 or 1;
Z is nitrogen when g=1 or oxygen when g=0;
W is —N(R₆)₃/X⁻ where R₆ may be selected to be identical or different from C₁-C₄₀ linear or branched alkyl radicals, formyl, C₁-C₁₀ linear or branched acyl, N,N-dimethylaminoethyl, 2-hydroxyethyl, 2-methoxyethyl, 2-ethoxyethyl, hydroxypropyl, methoxypropyl, ethoxypropyl or benzyl, preferably methyl, ethyl and n-propyl; and
X⁻ is an anion selected from acetate, methylsulfate or halide such as, chloride or bromide.

In an embodiment of the present invention, the N,N,N-trialkyl aminoalkyl acrylates, N,N,N-trialkyl aminoalkyl methacrylates are selected from N,N,N-trimethylaminomethyl (meth)acrylate, N,N,N-triethylaminomethyl (meth)acrylate, N,N,N-trimethylaminoethyl (meth)acrylate, N,N,N-triethylaminoethyl (meth)acrylate, N,N,N-trimethylaminobutyl (meth)acrylate, N,N,N-triethylaminobutyl (meth)acrylate, N,N,N-trimethylaminohexyl (meth)acrylate, N,N,N-trimethylaminooctyl (meth)acrylate, N,N,N-trimethylaminododecyl (meth)acrylate (meth) acryloyloxyhydroxypropyl trimethylammonium chloride and (meth)acryloyloxyhydroxypropyl triethylammonium chloride.

In another embodiment, the ethylenically unsaturated, quaternizable or quaternized monomer is 2-methylacryloxyethyltrimethyl ammonium chloride.

In an embodiment, the ethylenically unsaturated non-quaternizable monomer is selected from acrylamide and methacrylamide.

In another embodiment, the at least one cationic polymer containing at least one quaternary nitrogen atom is obtained by reacting a mixture comprising 2-methacryloxyethyl trimethyl ammonium chloride.

In an embodiment, the at least one cationic polymer containing at least one quaternary nitrogen atom is obtained by reacting a mixture comprising 2-methacryloxyethyl trimethyl ammonium chloride and acrylamide.

In an embodiment of the present invention, the at least one cationic polymer is obtained by polymerization reactions known in the art. The polymerization can be carried out, for example, as solution polymerization, bulk polymerization, emulsion polymerization, inverse emulsion polymerization, suspension polymerization, inverse suspension polymerization or precipitation polymerization without the methods which can be used being limited thereto.

In an embodiment of the present invention, the at least one cationic polymer containing at least one quaternary nitrogen atom has a weight average molecular weight (Mw) in the range of 100,000 to 9,000,000 g/mol or from 200,000 to 9,000,000 g/mol or from 300,000 to 7,000,000 g/mol.

In other embodiment, the cationic polymer has a charge density in the range of 0.5 to 10 meq/g, determined at a pH of 7.

The charge density of the cationic polymer is defined as the amount of cationic charge per gram of the given polymer. The charge density is measured using conductometric analysis at the pH specified. In the present invention, the charge density of the cationic polymer is measured at a pH of 7.

Compound of General Formula (I)

In an embodiment, the compatibilizer blend of the present invention comprises at least one compound of general formula (I)

R₁—(O—CH₂—CH(CH₃)ₓ—(O—CH₂—CH₂)_{y}—OH (I)

wherein
R₁ is a linear or branched, unsubstituted or substituted C₈-C₂₂-alkyl;
x is from 1 to 30;
y is from 1 to 30, and
the sum of x+y is in the range from 2 to 50.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₈-C₂₂ alkyl 8 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched C₈-C₂₂ alkyl include, but are not limited to, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, 2-ethylhexyl, 2-propyl heptyl, 2-butyl-1-octyl, 2-pentyl-1-nonyl, isooctyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, and isodocosyl.

In another embodiment, R₁ is linear or branched, unsubstituted n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, 2-ethylhexyl, 2-propyl heptyl, 2-butyl-1-octyl, 2-pentyl-1-nonyl, isooctyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, and isodocosyl.

In another embodiment, R₁ is linear or branched, unsubstituted n-octyl, n-nonyl, n-decyl, n-undecyl, n-dodecyl, n-tridecyl, n-tetradecyl, n-pentadecyl, n-hexadecyl, n-heptadecyl, n-octadecyl, 2-ethylhexyl, 2-propyl heptyl, 2-butyl-1-octyl, 2-pentyl-1-nonyl, isooctyl, isodecyl, isoundecyl, isododecyl, isotridecyl, isotetradecyl, isopentadecyl, isohexadecyl, isoheptadecyl and isooctadecyl.

In another embodiment, R₁ is linear or branched, unsubstituted n-octyl, n-nonyl, n-decyl, n-undecyl, n-dodecyl, n-tridecyl, n-tetradecyl, 2-ethylhexyl, 2-propyl heptyl, 2-butyl-1-octyl, 2-pentyl-1-nonyl, isooctyl, isodecyl, isoundecyl, isododecyl, isotridecyl and isotetradecyl.

In another embodiment, R₁ is linear or branched, unsubstituted n-decyl, n-undecyl, n-dodecyl, n-tridecyl, isodecyl, isoundecyl, isododecyl and isotridecyl.

In an embodiment, x is in the range of 1 to 20, preferably in the range of 1 to 15, more preferably in the range of 1 to 10.

In an embodiment, y is in the range of 1 to 20, preferably in the range of 1 to 15, more preferably in the range of 1 to 10.

In an embodiment, the sum of x+y is in the range of 2 to 40, preferably the sum of x+y is in the range of 2 to 35, more preferably the sum of x+y is in the range of 2 to 30, still more preferably the sum of x+y is in the range of 2 to 20, and most preferably the sum of x+y is in the range of 2 to 15.

A preferred compound of general formula (I) is PPG-1 trideceth-6.

Solvent

In an embodiment, the compatibilizer blend further comprises at least one solvent.

In an embodiment, the at least one solvent is selected from C₂ to C₁₈ acyclic or cyclic alcohols, C₃ to C₈ acyclic or cyclic ketones, C₃ to C₂ acyclic or cyclic carboxylic acid esters, N—(C₁-C₁₂)-alkyl-2-pyrrolidones, ethers, amides, cyclic carbonate ester and cyclic lactones.

In another embodiment, the at least one solvent is selected from ethanol, propanol, isopropanol, butanol, isobutanol, tert-butanol, pentanol, isopentanol, n-hexanol, isohexanol, cyclohexanol, 2-ethylhexanol, ethylene glycol, propylene glycol, butanediol, glycerol, diethylene glycol, butyl diglycol, hexylene glycol, acetone, diethyl ketone, tert-butyl methyl ketone, cyclohexanone, 2-ethylhexyl lactate, methyl oleate, ethyl oleate, 2-ethylhexyl laurate, octyl laurate, isopropyl laurate, isopropyl myristate, 2-ethylhexyl palmitate, isopropyl palmitate, butyl stearate, 2-ethylhexyl 2-ethylhexanoate, dimethyl adipate, di-n-butyl adipate, di-n-octyl adipate, bis-(2-ethylhexyl) adipate, di-n-nonyl adipate, di-iso-nonyl adipate, di-tridecyl adipate; di-n-octyl succinate, di-iso-octyl succinate, di-(iso-nonyl) cyclohexane-1,2-dicarboxylate, N-methylpyrrolidone, N-methyl-octylpyrrolidone, N-octylpyrrolidone, N-dodecyl pyrrolidone, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol ethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, N,N-dimethyl lactamide, N,N-dimethyloctamide, N,N-dimethyldecamide, N,N-dimethyldodecamide, propylene carbonate, ethylene carbonate, trimethylene carbonate, delta-valerolactone, gamma-valerolactone and mixtures thereof.

In another embodiment, the at least one solvent is selected from ethylene glycol, propylene glycol, butanediol, glycerol, diethylene glycol, butyl diglycol, hexylene glycol, acetone, diethyl ketone, tert-butyl methyl ketone, cyclohexanone, 2-ethylhexyl lactate, di-(iso-nonyl) cyclohexane-1,2-dicarboxylate, N-methylpyrrolidone, N-methyl-octylpyrrolidone, N-octylpyrrolidone, N-dodecyl pyrrolidone, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol ethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, N,N-dimethyl lactamide, N,N-dimethyloctamide, N,N-dimethyldecamide, N,N-dimethyldodecamide, propylene carbonate, ethylene carbonate, trimethylene carbonate and mixtures thereof.

In another embodiment, the at least one solvent is selected from propylene glycol, 2-ethylhexyl lactate, N-methylpyrrolidone, dipropylene glycol monomethyl ether, N,N-dimethyl lactamide, propylene carbonate and mixtures thereof.

In an embodiment, if the amount of the at least one fertilizer is in the range of 30.0 wt. % to 80.0 wt. %, based on the total weight of the aqueous composition, then addition of the at least one solvent is preferred.

The addition of the at least one solvent does not contribute to or adversely affect the stability of the composition, but it helps to obtain the desired fluidity such that the suspension concentrate of the pesticide and the fertilizer is able to pass through a 50-micron mesh.

In another embodiment, the at least one solvent is present in an amount in the range of 0.5 wt. % to 10.0 wt. %, based on the total weight of the aqueous composition.

Additive

In an embodiment, the compatibilizer blend comprises at least one additive.

In an embodiment, the at least one additive is selected from mineral oil, diesel, paraffins, kerosene, esters of saturated or unsaturated C₆-C₃₀ fatty acids and mixtures thereof.

Diesel is produced from the fractional distillation of crude oil between 200° C. to 350° C. at atmospheric pressure, resulting in a mixture of carbon chains that typically contain between 8 and 21 carbon atoms per molecule. In an embodiment, the diesel comprises paraffins, naphthenes and aromatic compounds. In an embodiment, the diesel comprises about 75% saturated hydrocarbons (paraffins including n, iso, and cycloparaffins), and 25% aromatic hydrocarbons (including naphthalenes and alkylbenzenes). In an embodiment, the diesel fuel contains the C₁₀-C₁₅ carbon chain.

Kerosene is a low viscosity, clear liquid formed from hydrocarbons obtained from the fractional distillation of petroleum between 150 and 275° C., resulting in a mixture with a density of 0.78-0.81 g/cm³ composed of carbon chains that typically contain between 10 and 16 carbon atoms per molecule. In an embodiment, kerosene comprises branched and straight chain alkanes, naphthenes and aromatic hydrocarbon and olefins. In an embodiment, kerosene contains 70% branched and straight chain alkanes and naphthenes (cycloalkanes), 25% aromatic hydrocarbons such as alkylbenzenes (single ring) and alkylnaphthalenes. Olefins are usually not present at more than 5% by volume.

In another embodiment, the at least one additive is selected from mineral oil, paraffins, esters of saturated or unsaturated C₆-C₃₀ fatty acids and mixtures thereof.

In an embodiment, the at least one additive has a hydrophilic-lipophilic balance (HLB) value in the range from 1.0 to 15.0.

The HLB value represents the hydrophilic-lipophilic balance of the molecule. The lower the HLB value the more hydrophobic the material is, and vice versa. The HLB values can be calculated according to the method given in Griffin, J. Soc. Cosmetic Chemists, 5 (1954) 249-256.

Griffith's method for nonionic surfactants as described in 1954 is as follows:

HLB=20×Mₕ/M

where

Mₕ is the molecular mass of the hydrophilic portion of the molecule; and

M is the molecular mass of the whole molecule.

In an embodiment, the esters of saturated or unsaturated C₆-C₃₀ fatty acids are selected from sorbitan esters of saturated or unsaturated C₆-C₃₀ fatty acids and propylene glycol esters of saturated or unsaturated C₆-C₃₀ fatty acids.

In an embodiment, the at least one additive is selected from paraffinum liquidum, mineral oil, propylene glycol caprate dicaprylate, sorbitan oleate and mixtures thereof.

The at least one additive may further comprise an organic acid such as citric acid. The acid is used for adjusting the pH of the compatibilizer blend. In an embodiment, the pH of the compatibilizer blend is in the range of 2-6, at 25° C.

Nutrient

In an embodiment, the aqueous composition of the present invention may further comprise at least one nutrient.

As used herein, “nutrient” refers to both micronutrients and macronutrients, such as, but not restricted to zinc, copper, manganese, boron, calcium, iron, calcium sulfate (gypsum), magnesium, molybdenum, chloride, selenium, phosphate, nitrogen, potassium and sulfur.

As used herein, “micronutrients” refers to elements required in small or trace amounts for plant growth, such as, but not restricted to molybdenum, nickel, copper, zinc, manganese, boron, iron and chloride.

As used herein, “macronutrients” refers to elements typically required in large amounts for plant growth, such as, but not restricted to, sulfur, phosphorus, phosphate, magnesium, calcium, potassium, nitrogen, oxygen, carbon and hydrogen.

In another embodiment, the at least one nutrient is a micronutrient.

In an embodiment, the micronutrient may be added in its free form or as micronutrient chelate formed by metal cation and complexing agents such as ethylene diamine tetraacetic acid. The complexing/chelating agents are employed to complex the metal cations which are then gradually released to the relevant ionic form, the micronutrient chelates protect metal cations against reduction in soil and facilitate efficient uptake by roots.

In an embodiment, the complexing/chelating agent is ethylenediamine tetra acetic acid (EDTA).

In an embodiment, the micronutrient is selected from diammonium zinc ethylene diamine tetra acetate and ferric ethylenediamine tetra acetate sodium salt.

In an embodiment, the micronutrient is an aminocarboxylate selected from methyl glycine diacetic acid (MGDA) and salts of methyl glycine diacetic acid.

Water

In an embodiment, the aqueous composition of the present invention contains water.

Water is present in an amount in the range of 10.0% to 80.0% by weight, based on the total weight of the aqueous composition.

The amount of water in the aqueous composition is the sum total of the water which is added to the aqueous composition and the water which may be already present in the components (a) agriculturally active compound, (b) fertilizer and (c) compatibilizer blend, of the aqueous composition of the present invention.

In an embodiment, the present invention relates to an aqueous composition comprising,
a) at least one agriculturally active compound,
b) at least one fertilizer, and
c) a compatibilizer blend comprising
   (i) at least one cationic polymer containing at least one quaternary nitrogen atom;
   (ii) at least one compound of general formula (I)

R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof.

In an embodiment, the present invention relates to an aqueous composition comprising,
a) at least one agriculturally active compound,
b) at least one fertilizer, and
c) a compatibilizer blend comprising
   (i) at least one cationic polymer containing at least one quaternary nitrogen atom which is a reaction product of:
   (A) at least one ethylenically unsaturated, quaternizable or quaternized monomer; and
   (B) optionally at least one ethylenically unsaturated, non-quaternizable monomer.
   (ii) at least one compound of general formula (I)

R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof.

In an embodiment, the present invention relates to an aqueous composition comprising,
a) at least one agriculturally active compound,
b) at least one fertilizer selected from ammonium sulfate, ammonium polyphosphate and urea ammonium nitrate, and
c) a compatibilizer blend comprising
   (i) at least one cationic polymer containing at least one quaternary nitrogen atom;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof.

In an embodiment, the present invention relates to an aqueous composition comprising,
a) at least one agriculturally active compound selected from herbicide, insecticide and fungicide,
b) at least one fertilizer selected from ammonium sulfate, ammonium polyphosphate and urea ammonium nitrate, and
c) a compatibilizer blend comprising
   (i) at least one cationic polymer containing at least one quaternary nitrogen atom;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30,
the sum of x+y is in the range from 2 to 50; and
(iii) at least one additive selected from mineral oil, paraffins, esters of saturated or unsaturated C₆-C₃₀ fatty acids, and mixtures thereof.

In an embodiment, the present invention relates to an aqueous composition comprising,
a) at least one agriculturally active compound selected from herbicide, insecticide and fungicide,
b) at least one fertilizer selected from ammonium sulfate, ammonium polyphosphate and urea ammonium nitrate, and
c) a compatibilizer blend comprising
   (i) at least one cationic polymer containing at least one quaternary nitrogen atom which is a reaction product of:
   (A) at least one ethylenically unsaturated, quaternizable or quaternized monomer; and
   (B) optionally at least one ethylenically unsaturated, non-quaternizable monomer;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof.

In an embodiment, the present invention relates to an aqueous composition comprising,
a) at least one agriculturally active compound,
b) at least one fertilizer, and
c) a compatibilizer blend comprising
   (i) at least one cationic polymer containing at least one quaternary nitrogen atom;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof; and
(iv) at least one solvent.

In an embodiment, the present invention relates to an aqueous composition comprising,
a) at least one agriculturally active compound,
b) at least one fertilizer,
c) a compatibilizer blend comprising
   (i) at least one cationic polymer containing at least one quaternary nitrogen atom;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof; and
(iv) at least one nutrient.

In an embodiment, the present invention relates to an aqueous composition comprising,
a) at least one agriculturally active compound,
b) at least one fertilizer,
c) a compatibilizer blend comprising
   (i) at least one cationic polymer containing at least one quaternary nitrogen atom;
   (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, paraffins, esters of saturated or unsaturated C₆-C₃₀ fatty acids and mixtures thereof; and
(iv) at least one nutrient, wherein the nutrient is a micronutrient.

In another aspect, the presently claimed invention is directed to a method of making an aqueous agricultural composition comprising contacting at least one agriculturally active compound with at least one fertilizer and a compatibilizer blend.

In an embodiment, the presently claimed invention is directed to a method of making an aqueous agricultural composition comprising contacting at least one agriculturally active compound with at least one fertilizer, at least one nutrient and a compatibilizer blend.

In an embodiment, the presently claimed invention is directed to a method of making an aqueous agricultural composition comprising contacting at least one agriculturally active compound with at least one fertilizer, at least one solvent and a compatibilizer blend.

### Advantages

The present invention offers one or more of following advantages:

1. The composition of the present invention provides a stable combination of fertilizer and pesticide without any physical incompatibility between the two.

2. A higher concentration of fertilizer, up to 80% by weight of the final weight of the composition, is achieved by the composition of the present invention, without any adverse effect on the stability of the composition.

### Embodiments

1. An aqueous composition comprising
   a) at least one agriculturally active compound,
   b) at least one fertilizer, and
   c) a compatibilizer blend comprising
      (i) at least one cationic polymer containing at least one quaternary nitrogen atom;
      (ii) at least one compound of general formula (I)

R₁—(O—CH₂—CH(CH))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, diesel, paraffins, kerosene, esters of saturated or unsaturated C₆-C₃₀ fatty acids and mixtures thereof.
2. The aqueous composition according to embodiment 1, wherein (i) the at least one cationic polymer containing at least one quaternary nitrogen atom is a reaction product of:
   (A) at least one ethylenically unsaturated, quaternizable or quaternized monomer; and
   (B) optionally at least one ethylenically unsaturated, non-quaternizable monomer.
3. The aqueous composition according to embodiment 2, wherein (A) the at least one ethylenically unsaturated, quaternizable or quaternized monomer is 2-methylacryloxyethyltrimethyl ammonium chloride.
4. The aqueous composition according to embodiment 2, wherein (B) the at least one ethylenically unsaturated non-quaternizable monomer are selected from acrylamide and methacrylamide.
5. The aqueous composition according to one or more of embodiments 1 to 4, wherein the at least one cationic polymer containing at least one quaternary nitrogen atom is obtained by reacting a mixture comprising 2-methacryloxyethyl trimethyl ammonium chloride.
6. The aqueous composition according to one or more of embodiments 1 to 4, wherein the at least one cationic polymer containing at least one quaternary nitrogen atom is obtained by reacting a mixture comprising 2-methacryloxyethyl trimethyl ammonium chloride and acrylamide.
7. The aqueous composition according to embodiment 1, wherein R₁ is a linear or branched, unsubstituted C₁₃ alkyl; x is 1 and y is 6.
8. The aqueous composition according to embodiment 1, wherein (iii) the at least one additive has a hydrophilic-lipophilic balance (HLB) value in the range from 1.0 to 15.0.
9. The aqueous composition according to embodiment 1, wherein esters of saturated or unsaturated C₆-C₃₀ fatty acids are selected from sorbitan esters of saturated or unsaturated C₆-C₃₀ fatty acids and propylene glycol esters of saturated or unsaturated C₆-C₃₀ fatty acids.
10. The aqueous composition according to one or more of embodiments 1 to 9, wherein the aqueous composition has a pH in the range from 1.0 to 8.0.
11. The aqueous composition according to embodiment 1, wherein the fertilizer is selected from inorganic ammonium salts.
12. The aqueous composition according to embodiment 11, wherein the inorganic ammonium salts are selected from ammonium chloride, calcium ammonium nitrate, anhydrous ammonia, ammonium sulfate, urea ammonium nitrate, super phosphoric acid, diammonium phosphate, ammonium phosphate sulfate, ammonium phosphate sulfate nitrate, nitro phosphate, urea ammonium phosphate, mono ammonium phosphate, nitro phosphate, ammonium nitrate phosphate, ammonium polyphosphate, ammonium phosphate, mono potassium phosphate and urea phosphate.
13. The aqueous composition according to embodiment 12, wherein the fertilizer is selected from ammonium sulfate, ammonium polyphosphate and urea ammonium nitrate.
14. The aqueous composition according to one or more of claims 1 to 13, wherein the fertilizer is present in amount in the range of 15.0 wt. % to 80.0 wt. %, based on the total weight of the aqueous composition.
15. The aqueous composition according to embodiment 1, wherein the at least one agriculturally active compound is a pesticide selected from herbicide, insecticide and fungicide.
16. The aqueous composition according to embodiment 15, wherein the herbicide is selected from acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, pyrimidinedione and acetolactate synthase inhibitors.
17. The aqueous composition according to embodiment 15, wherein the insecticide is selected from organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds and mixed function oxidase inhibitors.
18. The aqueous composition according to embodiment 15, wherein the fungicide is selected from respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors and plant defense inducers.
19. The aqueous composition according to embodiment 15 or 16, wherein the herbicide is selected from pyrimidinediones.
20. The aqueous composition according to one or more of claims 1 to 19, wherein the at least one agriculturally active compound is present in an amount in the range of 1.0 wt. % to 20.0 wt. %, based on the total weight of the aqueous composition.
21. The aqueous composition according to one or more of embodiments 1 to 20, wherein the compatibilizer blend is present in an amount in the range of 1.0 wt. % to 10.0 wt. %, based on the total weight of the aqueous composition.
22. The aqueous composition according to one or more of embodiments 1 to 21, wherein the compatibilizer blend is present in an amount in the range of 1.0 wt. % to 7.0 wt. %, based on the total weight of the aqueous composition.
23. The aqueous composition according to one or more of embodiments 1 to 22, wherein the compatibilizer blend further comprises a copolymer of (meth)acrylate and stearyl (meth)acrylate.
24. The aqueous composition according to one more of embodiments 1 to 23, wherein the compatibilizer blend further comprises at least one solvent.
25. The aqueous composition according to embodiment 24, wherein the at least one solvent is selected from C₂ to C₁₈ acyclic or cyclic alcohols, C₃ to C₈ acyclic or cyclic ketones, C₃ to C₂ acyclic or cyclic carboxylic acid esters, N—(C₁-C₁₂)-alkyl-2-pyrrolidones, ethers, amides, cyclic carbonate ester and cyclic lactones.
26. The aqueous composition according to embodiment 24 or 25, wherein the at least one solvent is selected from ethanol, propanol, isopropanol, butanol, isobutanol, tert-butanol, pentanol, isopentanol, n-hexanol, isohexanol, cyclohexanol, 2-ethylhexanol, ethylene glycol, propylene glycol, butanediol, glycerol, diethylene glycol, butyl diglycol, hexylene glycol, acetone, diethyl ketone, tert-butyl methyl ketone, cyclohexanone, 2-ethylhexyl lactate, methyl oleate, ethyl oleate, 2-ethylhexyl laurate, octyl laurate, isopropyl laurate, isopropyl myristate, 2-ethylhexyl palmitate, isopropyl palmitate, butyl stearate, 2-ethylhexyl 2-ethylhexanoate, dimethyl adipate, di-n-butyl adipate, di-n-octyl adipate, bis-(2-ethylhexyl) adipate, di-n-nonyl adipate, di-iso-nonyl adipate, di-tridecyl adipate; di-n-octyl succinate, di-iso-octyl succinate, di-(iso-nonyl) cyclohexane-1,2-dicarboxylate, N-methylpyrrolidone, N-methyl-octylpyrrolidone, N-octylpyrrolidone, N-dodecyl pyrrolidone, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol ethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, N,N-dimethyl lactamide, N,N-dimethyloctamide, N,N-dimethyldecamide, N,N-dimethyldodecamide, propylene carbonate, ethylene carbonate, trimethylene carbonate, delta-valerolactone, gamma-valerolactone and mixtures thereof.
27. The aqueous composition according to one or more of embodiments 24 to 26, wherein the at least one solvent is present in an amount in the range of 0.5 wt. % to 10.0 wt. %, based on the total weight of the aqueous composition.
28. The aqueous composition according to one more of claims 1 to 27, further comprising at least one nutrient.
29. The aqueous composition according to claim 28, wherein the nutrient is a micronutrient.
30. The aqueous composition according to claim 29, wherein the micronutrient is selected from diammonium zinc ethylene diamine tetra acetate, ferric ethylenediamine tetra acetate sodium salt, aminocarboxylate selected from methyl glycine diacetic acid (MGDA) and salts of methyl glycine diacetic acid.
31. A method of making an aqueous composition according to one or more of embodiments 1 to 30, comprising contacting at least one agriculturally active compound with at least one fertilizer and a compatibilizer blend, wherein the compatibilizer blend comprises
   (i) at least one cationic polymer containing at least one quaternary nitrogen atom;
   (ii) at least one compound of general formula (I)

R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
(iii) at least one additive selected from mineral oil, diesel, paraffins, kerosene, esters of saturated or unsaturated C₆-C₃₀ fatty acids, and mixtures thereof.

### EXAMPLES

Compounds

Fertilizer: Ammonium polyphosphate solution 10-34-0: pH 6.0, 10% N and 34% P₂O₅, (contains 30%-60% ammonium polyphosphate and 40%-70% water) was obtained from Liquid Products LLC

Herbicide Sharpen®: Saflufenacil was obtained from BASF SE

Compatibilizer blend
(v) Cationic polymer containing at least one quaternary nitrogen atom
   Polyquaternium-32
   Polyquaternium-37
   Poly (methacryloxyethyl) trimethyl ammonium chloride
(vi) compound of general formula (I)
   PPG-1 trideceth-6
(vii) Additive
   paraffinum liquidum,
   mineral oil
   propylene glycol caprate dicaprylate
   sorbitan oleate
   citric acid
   Copolymer of (meth)acrylate and stearyl (meth)acrylate, copolymer of acrylate and stearyl (meth)acrylate

Solvents:

N,N-dimethyl lactamide

N-methylpyrrolidone

Propylene carbonate

Propylene glycol

Dipropylene glycol methyl ether

Nutrients

Trisodium salt of methylglycinediacetic acid

Diammonium zinc ethylenediamine tetra acetate

Ferric ethylenediamine tetra acetate sodium salt were available from BASF SE.

Stability Assessment

The stability at room temperature and at 40° C. is measured by visual observation. If the aqueous composition does not settle down and remains suspended with a milky appearance, the aqueous composition is said to be stable.

Procedure for Preparation of Aqueous Compositions According to Examples 1 to 7:

Equipment: Overhead stirring and beaker. Speed of stirring: 1000 to 1300 rpm. Graduated cylinder with stopper.

To 55 ml water was added 40 ml ammonium polyphosphate solution, compatibilizer blend as specified in Table-1 and the mixture was stirred for 5 minutes at a speed of 1000 to 1300 rpm. To this mixture was added the 5 ml herbicide Sharpen and the solution was stirred for 5 minutes. The resulting solution was poured into a graduated cylinder and kept undisturbed at room temperature for at least 24 hours.

TABLE 1

| | | | | | Copolymer of | propylene | | | |
|---|---|---|---|---|---|---|---|---|---|
| | Poly- | Poly- | Mineral | | acrylate | glycol | | Stability | |
| Example | quaternium | quaternium | oil | PPG-1 | and stearyl | dicaprylate/ | Sorbitan | at room | Stability |
| no. | 32 | 37 | (g) | trideceth-6 | (meth)acrylate | dicaprate | Oleate | temperature | at 40° C. |
| Example 1 | 1.6 | | 0.96 | 0.192 | — | — | — | Stable for | Stable for |
| | | | | | | | | 24 hours | 30 days |
| Example 2 | 2.75 | — | 1.65 | 0.33 | — | — | — | Stable for | Stable for |
| | | | | | | | | 24 hrs | 30 days |
| Example 3 | — | 1.625 | 1.17 | 0.195 | | | 0.065 | Stable for | Stable for |
| | | | | | | | | 24 hrs | 30 days |
| Example 4 | — | 2.625 | 1.89 | 0.315 | | | 0.105 | Stable for | Stable for |
| | | | | | | | | 24 hrs | 30 days |
| Example 5 | — | 0.75 | | 0.12 | 0.03 | 0.525 | — | Stable for | Stable for |
| | | | | | | | | 24 hrs | 30 days |
| Example 6 | — | 1.3 | | 0.21 | 0.052 | 0.91 | — | Stable for | Stable for |
| | | | | | | | | 24 hrs | 30 days |
| Example 7 | | 2 | | 0.32 | 0.08 | 1.4 | | Stable for | Stable for |
| | | | | | | | | 24 hrs | 30 days |

The data in Table-1 indicate that the stability of a suspension concentrate of a herbicide and a fertilizer is achieved by a compatibilizer blend comprising at least one cationic polymer containing at least one quaternary nitrogen atom (such as a polyquaternium), a compound of general formula-I (such as PPG-1 trideceth-6) and at least one additive (in this case mineral oil, propylene glycol caprate dicaprylate or sorbitan oleate).

The compositions of example no. 1 to 7 passes through a mesh with a size of 50. This indicates that the compositions will not pose a threat of clogging the spray gun during spraying on the fields.

### Comparative Examples

The compositions of comparative examples 1 to 24 were prepared by the same procedure as outlined for examples 1 to 7.

Amount of mineral oil is specified in Table-2

Amount of PPG-1 Trideceth-6 is specified in Table-3

Amount of Polyquaternium-37 is specified in Table-4

Fertilizer ammonium polyphosphate solution: 20 ml

Water: 75 ml

Herbicide Sharpen: 5 ml

TABLE 2

| Example no. | Mineral oil (g) | Stability |
|---|---|---|
| Comparative example 1 | 1.134 | Unstable |
| Comparative example 2 | 1.62 | Unstable |
| Comparative example 3 | 1.71 | Unstable |
| Comparative example 4 | 1.8 | Unstable |
| Comparative example 5 | 1.89 | Unstable |
| Comparative example 6 | 1.98 | Unstable |

TABLE 3

| Example no. | PPG-1 Trideceth-6 (g) | Stability |
|---|---|---|
| Comparative example 7 | 0.189 | Unstable |
| Comparative example 8 | 0.27 | Unstable |
| Comparative example 9 | 0.285 | Unstable |
| Comparative example 10 | 0.3 | Unstable |
| Comparative example 11 | 0.315 | Unstable |
| Comparative example 12 | 0.33 | Unstable |

TABLE 4

| Example no. | Polyquaternium-37 | Stability |
|---|---|---|
| Comparative example 13 | 1.58 | Unstable |
| Comparative example 14 | 2.25 | Unstable |
| Comparative example 15 | 2.37 | Unstable |
| Comparative example 16 | 2.5 | Unstable |
| Comparative example 17 | 2.63 | Unstable |
| Comparative example 18 | 2.75 | Unstable |

TABLE 5

| Example no. | Mineral oil (g) | PPG-1 trideceth-6 (g) | Stability |
|---|---|---|---|
| Comparative | 1.134 | 0.189 | Unstable |
| example 19 | | | |
| Comparative | 1.62 | 0.27 | Unstable |
| example 20 | | | |
| Comparative | 1.71 | 0.285 | Unstable |
| example 21 | | | |
| Comparative | 1.8 | 0.3 | Unstable |
| example 22 | | | |
| Comparative | 1.89 | 0.315 | Unstable |
| example 23 | | | |
| Comparative | 1.98 | 0.33 | Unstable |
| example 24 | | | |

In Table-2, comparative examples 1-6 (only mineral oil was present in the compatibilizer blend), Table-3, comparative examples 7 to 12 (only PPG-1 trideceth-6 was present in the compatibilizer blend), Table-4, comparative examples 13 to 18 (only Polyquaternium-37 was present in the compatibilizer blend) and Table-5, comparative examples 19 to 24 (a combination of mineral oil and PPG-1 trideceth-6) the composition settled down at the bottom within 2 hours and hence was unstable.

These ingredients alone (Table 2, 3, and 4) or if one of them is not present (table-5) do not stabilize the suspension concentrate of an herbicide and a fertilizer.

Composition containing solvent, with and without micronutrient

The compositions of examples 8 to 19 were prepared by the same procedure as outlined for examples 1 to 7.

Fertilizer ammonium polyphosphate solution: 40 ml

Water: 55 ml

Herbicide Sharpen: 5 ml

Compatibilizer blend comprising 2 g Polyquaternium-37, 2 g Poly (methacryloxyethyl) trimethyl ammonium chloride, 1.4 g propylene glycol dicaprylate/dicaprate, 0.32 g PPG-1 Trideceth-6 and 0.08 g copolymer of acrylate and steary (meth)acrylate.

TABLE 6

| | | | | | Stability |
|---|---|---|---|---|---|
| Example | | Amount | | Amount | at room |
| no. | Solvent | (g) | micronutrient | (g) | temperature |
| Example 8 | N,N-dimethyl | 2.3 | — | — | Stable for |
| | lactamide | | | | 24 hours |
| Example 9 | N,N-dimethyl | 2 | — | — | Stable for |
| | lactamide | | | | 24 hours |
| Example 10 | N-methyl | 2.25 | — | — | Stable for |
| | pyrrolidone | | | | 24 hours |
| Example 11 | Propylene | 2.25 | — | — | Stable for |
| | carbonate | | | | 24 hours |
| Example 12 | Propylene | 2.25 | — | — | Stable for |
| | glycol | | | | 24 hours |
| Example 13 | Dipropylene | 2.25 | — | — | Stable for |
| | glycol methyl | | | | 24 hours |
| | ether | | | | |
| Example 14 | N,N-dimethyl | 2 | trisodium salt of | 1 | Stable for |
| | lactamide | | methylglycinediacetic | | 24 hours |
| | | | acid | | |
| Example 15 | N,N-dimethyl | 2 | trisodium salt of | 10 | Stable for |
| | lactamide | | methylglycinediacetic | | 24 hours |
| | | | acid | | |
| Example 16 | N,N-dimethyl | 2 | diammonium Zinc | 1 | Stable for |
| | lactamide | | EDTA | | 24 hours |
| Example 17 | N,N-dimethyl | 2 | diammonium Zinc | 10 | Stable for |
| | lactamide | | EDTA | | 24 hours |
| Example 18 | N,N-dimethyl | 2 | ferric ethylene | 1 | Stable for |
| | lactamide | | diamine tetra acetate | | 24 hours |
| | | | sodium salt | | |
| Example 19 | N,N-dimethyl | 2 | ferric ethylene | 10 | Stable for |
| | lactamide | | diamine tetra acetate | | 24 hours |
| | | | sodium salt | | |

As indicated in Table-6, Example nos. 8 to 13, by addition of a solvent, stable suspension concentrates of herbicide and fertilizer with a higher concentration of fertilizer, to the extent of 40%, are obtained.

Addition of a micronutrient, as shown in examples 14 to 19 of Table-6, does not adversely affect the stability of the composition and the compositions are stable for 24 hours at room temperature. All these compositions of example no. 8 to 19 passes through a mesh of a size of 50.

1. An aqueous composition comprising,
a) at least one agriculturally active compound,
b) at least one fertilizer, and
c) a compatibilizer blend comprising
A) at least one cationic polymer containing at least one quaternary nitrogen atom;
B) at least one compound of general formula (I)
R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
C) at least one additive selected from the group consisting of mineral oil, diesel, paraffins, kerosene, esters of saturated or unsaturated C₆-C₃₀ fatty acids and mixtures thereof.

2. The aqueous composition according to claim 1, wherein (i) the at least one cationic polymer containing at least one quaternary nitrogen atom is a reaction product of:
(A) at least one ethylenically unsaturated, quaternizable or quaternized monomer; and
(B) optionally at least one ethylenically unsaturated, non-quaternizable monomer.

3. The aqueous composition according to claim 2, wherein (A) the at least one ethylenically unsaturated, quaternizable or quaternized monomer is 2-methylacryloxyethyltrimethyl ammonium chloride.

4. The aqueous composition according to claim 2, wherein (B) the at least one ethylenically unsaturated, non-quaternizable monomer is selected from the group consisting of acrylamide and methacrylamide.

5. The aqueous composition according to claim 1, wherein R₁ is a linear or branched, unsubstituted C₁₃ alkyl; x is 1 and y is 6.

6. The aqueous composition according to claim 1, wherein (iii) the at least one additive has an HLB value in the range from 1.0 to 15.0.

7. The aqueous composition according to claim 1, wherein the esters of saturated or unsaturated C₆-C₃₀ fatty acids are selected from the group consisting of sorbitan esters of saturated or unsaturated C₆-C₃₀ fatty acids and propylene glycol esters of saturated or unsaturated C₆-C₃₀ fatty acids.

8. The aqueous composition according to claim 1, wherein the aqueous composition has a pH in the range from 1.0 to 8.0.

9. The aqueous composition according to claim 1, wherein the fertilizer is selected from the group consisting of ammonium chloride, calcium ammonium nitrate, anhydrous ammonia, ammonium sulfate, urea ammonium nitrate, super phosphoric acid, diammonium phosphate, ammonium phosphate sulfate, ammonium phosphate sulfate nitrate, nitro phosphate, urea ammonium phosphate, mono ammonium phosphate, nitro phosphate, ammonium nitrate phosphate, ammonium polyphosphate, ammonium phosphate, mono potassium phosphate and urea phosphate.

10. The aqueous composition according to claim 9, wherein the fertilizer is selected from the group consisting of ammonium sulfate, ammonium polyphosphate and urea ammonium nitrate.

11. The aqueous composition according to claim 1, wherein the fertilizer is present in amount in the range of 15.0 wt. % to 80.0 wt. %, based on the total weight of the aqueous composition.

12. The aqueous composition according to claim 1, wherein the at least one agriculturally active compound is a pesticide selected from the group consisting of herbicide, insecticide and fungicide.

13. The aqueous composition according to claim 1, wherein the amount of the at least one agriculturally active compound is in the range of 1.0 wt. % to 20.0 wt. %, based on the total weight of the aqueous composition.

14. The aqueous composition according to claim 1, wherein the compatibilizer blend is present in an amount in the range of 1.0 wt. % to 10.0 wt. % based on the total weight of the aqueous composition.

15. The aqueous composition according to claim 1, wherein the compatibilizer blend further comprises a copolymer of (meth)acrylate and stearyl (meth)acrylate.

16. The aqueous composition according to claim 1, wherein the compatibilizer blend further comprises at least one solvent.

17. The aqueous composition according to claim 16, wherein the at least one solvent is selected from the group consisting of C₂ to C₁₈ acyclic or cyclic alcohols, C₃ to C₈ acyclic or cyclic ketones, C₃ to C₂₀ acyclic or cyclic carboxylic acid esters, N—(C₁-C₁₂)-alkyl-2-pyrrolidones, ethers, amides, cyclic carbonate ester and cyclic lactones.

18. The aqueous composition according to claim 16, wherein the at least one solvent is present in an amount in the range of 0.5 wt. % to 10.0 wt. %, based on the total weight of the aqueous composition.

19. The aqueous composition according to claim 18, further comprising at least one nutrient.

20. A method of making an aqueous composition according to claim 1, comprising contacting at least one agriculturally active compound with at least one fertilizer and a compatibilizer blend, wherein the compatibilizer blend comprises
a) at least one cationic polymer containing at least one quaternary nitrogen atom;
b) at least one compound of general formula (I)
R₁—(O—CH₂—CH(CH₃))ₓ—(O—CH₂—CH₂)_{y}—OH
wherein
R₁ is a linear or branched, unsubstituted or substituted C₈-C₂₂-alkyl;
x is from 1 to 30;
y is from 1 to 30, and
the sum of x+y is in the range from 2 to 50; and
a) at least one additive selected from the group consisting of mineral oil, diesel, paraffins, kerosene, esters of saturated or unsaturated C₆-C₃₀ fatty acids and mixtures thereof.
